(19) United States
(12) Patent Application Publication
(10) Pub. No.: US 2025/0182320 A1
(43) Pub. Date: Jun. 5, 2025

(54) AUTOMATIC RANGE AND GEO-REFERENCING FOR IMAGE PROCESSING SYSTEMS AND METHODS

(71) Applicant: Teledyne FLIR Defense, Inc., Thousand Oaks, CA (US)

(72) Inventor: Jörgen Lundberg, Täby (SE)

(21) Appl. No.: 18/962,994

(22) Filed: Nov. 27, 2024

Related U.S. Application Data
(60) Provisional application No. 63/605,439, filed on Dec. 1, 2023.

(51) Int. Cl. G06T 7/73; G01S 17/08; G01S 17/87; G06F 16/29; G06V 10/764

(52) U.S. Cl. CPC G06T 7/73; G01S 17/08; G01S 17/87; G06F 16/29; G06V 10/764

(57) ABSTRACT

Systems and methods for automatically determining the physical locations of objects detected within captured images includes a storage system holding geographic reference points associated with the image capture device's field of view, and a logic device generating estimated object locations based on image capture parameters and object information from the image including pixel offsets, object classifications, and geo-reference points, and refining these estimations. The image capture device captures images of scene and generates parameters for its location, height, azimuth, and tilt. A laser range finder or other method may be used to measure distances between the image capture device and geo-reference points in the field of view to populate the storage system. Implementations include video surveillance, traffic monitoring, and other systems.

### CROSS REFERENCE TO RELATED APPLICATIONS

This application claims priority to and the benefit of U.S. Provisional Patent Application No. 63/605,439 filed Dec. 1, 2023 and entitled “AUTOMATIC RANGE AND GEO-REFERENCING FOR IMAGE PROCESSING SYSTEMS AND METHODS,” which is incorporated herein by reference in its entirety.

### TECHNICAL FIELD

Embodiments of the present disclosure relate generally to image processing systems and methods and, more particularly for example, to systems and methods for determining a range and/or geographic position of an object detected by a video and/or image capture system.

### BACKGROUND

In the field of image processing, there is an ongoing need for efficient and reliable methods to detect and classify objects of interest within an image, such as an image representing a field of view of an image capture device. In one approach, an image classifier analyzes one or more images to identify objects therein and match the identified object with a known object classification. For example, a classifier may include a trained neural network configured to identify a vehicle type, vehicle make, vehicle model, and year of manufacture. The accuracy of object identification and classification may depend on the object location in the image and geographical location in the scene. For example, the system may need to differentiate between a small object and an object that appears small because it is far away from the image capture device.

In view of the foregoing, there is a continued need for improved object detection and classification solutions that are easily adaptable to various object detection and classification scenarios, including object locations in a scene, and that provide performance or other advantages over conventional systems.

### SUMMARY

The present disclosure includes various embodiments of improved object detection and classification systems and methods. In some embodiments, object detection and classification systems and methods include automatic range and geo-referencing of objects detected in a captured image of a scene.

The scope of the invention is defined by the claims, which are incorporated into this section by reference. A more complete understanding will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1A illustrates an example process for setting up an image capture device for automatic geo-location estimation for multiple identified objects, in accordance with embodiments of the present disclosure.

FIG. 1B illustrates an example process for processing captured images for automatic geo-location estimation for multiple identified objects, in accordance embodiments of the present disclosure.

FIG. 2 illustrates an example image classification system, in accordance with embodiments of the present disclosure.

FIG. 3 illustrates an example host image classification system, that may be used with image classification system of FIG. 2, in accordance with embodiments of the present disclosure.

FIG. 4A illustrates an example process for estimating an object range and/or location based on an object classification, in accordance with embodiments of the present disclosure.

FIG. 4B illustrates an example process for estimating an object range and/or location based on a pixel offset of an object in a captured image, in accordance with embodiments of the present disclosure.

FIG. 4C illustrates an example process for estimating an object range and/or location based on a comparison with geo-reference points, in accordance with embodiments of the present disclosure.

FIG. 4D illustrates an example process for refining the estimates of FIGS. 4A-C, in accordance with embodiments of the present disclosure.

Embodiments of the disclosure and their advantages are best understood by referring to the detailed description that follows. It should be appreciated that like reference numerals are used to identify like elements illustrated in one or more of the figures.

### DETAILED DESCRIPTION

In various object detection and/or classification systems (e.g., a video surveillance system, a traffic monitoring system, or other system), an image capture device (e.g., a camera) is configured to an image a scene for further processing that may include object detection and/or classification. In many scenarios, it is desirable for the system to understand where the objects are geographically in the scene so that the object and/or an accompanying event can be properly assessed. In some systems, a location of an object or event may be determined manually by a user operating a laser range finder (LRF).

Manually operating a LRF, however, has limitations in conventional systems. For example, conventional systems require operation of the LRF by the user, and range determinations are limited to only one object at a time. In many systems, captured image data is automatically analyzed to detect and classify moving objects, which may include multiple objects in the scene at the same time. The availability, speed, and reliability of a human operator, who is limited to directing the LRF towards each individual object to get range and location information, can be burdensome and generate unreliable/missed object data.

Embodiments of the present disclosure includes systems and methods for automated geo-referencing, including geo-referencing of multiple objects simultaneously, that overcome deficiencies of conventional system. In various embodiments, a system is configured to combine parameters from different data sources to: (i) approximate an object location based on a location and orientation of a camera (or other image capture device that may be used by the system), which may be based on a local and/or global coordinate system (e.g., based on a local coordinate system of the camera, based on the camera's geographic latitude and longitude, or other coordinate system) and camera parameters (e.g., installation height, azimuth, elevation, position in the field of view (FOV) where the object appears, and/or other criteria); (ii) approximate a range from the camera to the object, based on, for example, an object classification, reference object size, how much of the FOV that the object covers, and/or other criteria; (iii) approximate a range based on stored LRF reference points in a virtual three-dimensional environment; and (iv) map together the two-dimensional and three-dimensional information available to the system from steps (i)-(iii) to generate a refined location estimate.

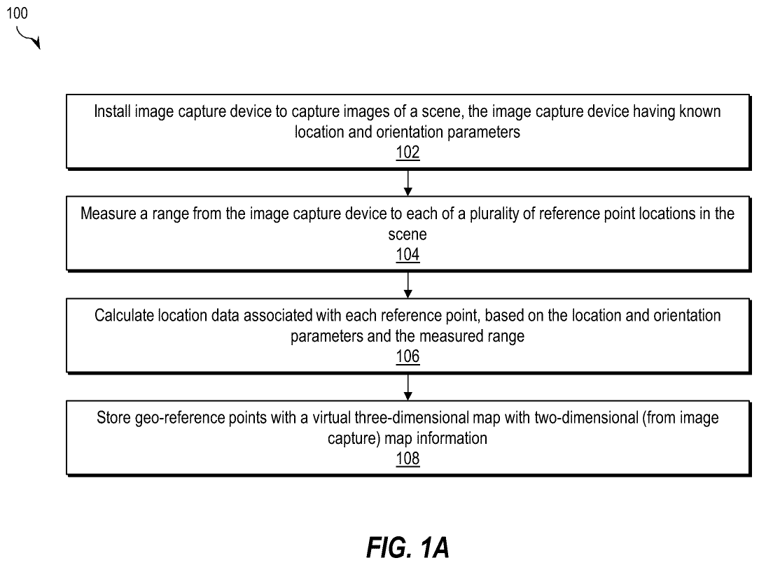

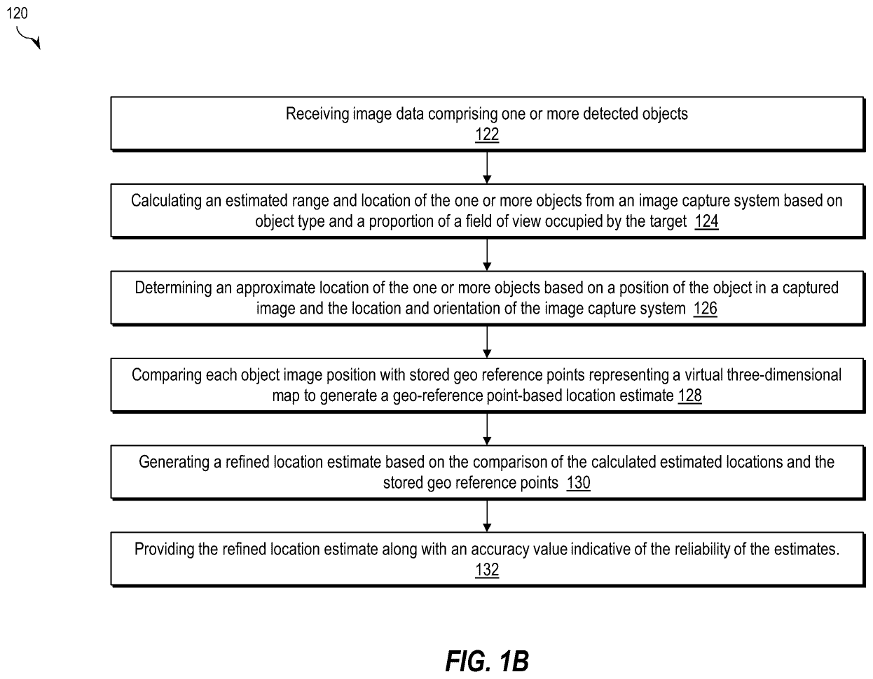

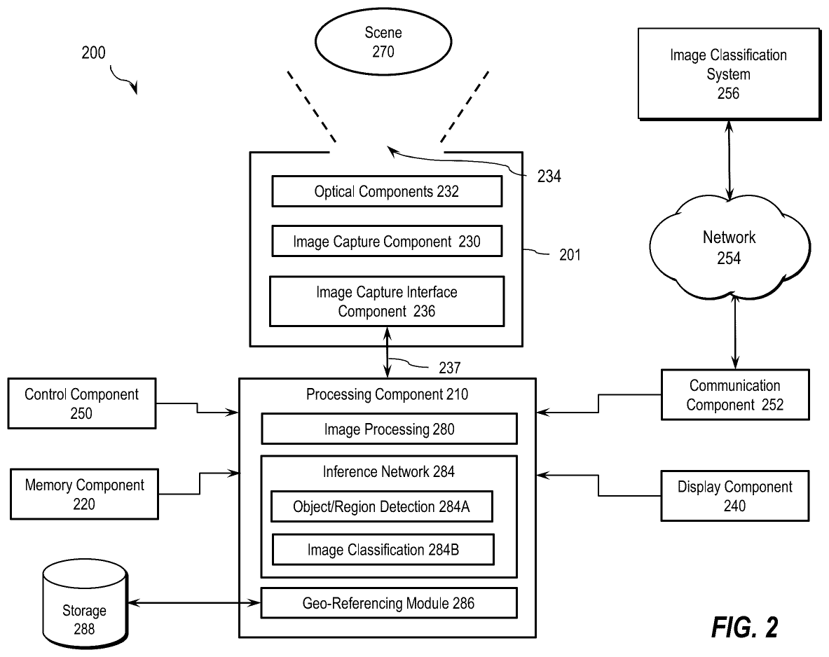

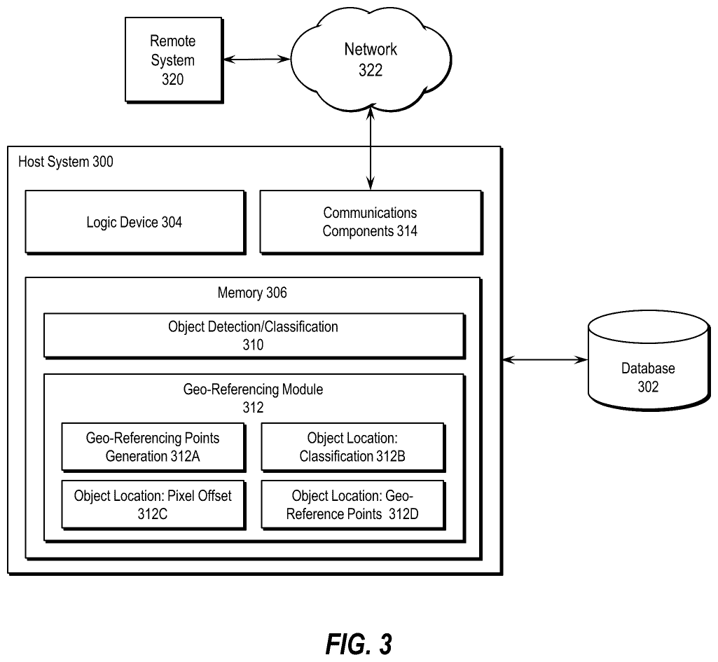

FIGS. 1A-B illustrate example processes for implementing automatic geo-location estimation for multiple identified objects in a line of sight/field of view of an image capture device, in accordance with embodiments of the present disclosure. In various implementations, for example, the image capture device may be a component of a video surveillance system (e.g., as illustrated in the embodiments of FIGS. 2-3) that is positioned to capture images of a scene. The image capture device and/or other components of the video surveillance system include one or more logic devices configured to implement the processes of FIGS. 1A-B, which facilitates automation of object detection, classification, and location determinations, and the elimination and/or reduction of user operations to perform such tasks.

FIG. 1A illustrates an example process 100 for setting up an image capture device for automatic geo-location estimation for multiple identified objects, in accordance with embodiments of the present disclosure. In operation 102, an image capture device is installed at a location to capture images of a scene within a field of view of the image capture device. In some embodiments, the process 100 may be implemented using one or more of the systems or components illustrated in FIGS. 2 and 3. In various embodiments, the image capture device may be implemented in a video surveillance system, a traffic monitoring system, and/or other system configured to capture images of scene, detect and/or classify objects in the scene, and determine a geo-location of the detected object.

The image capture device is installed at known location and operates with a known orientation as indicated by device parameters. For example, the image capture device may be installed at a fixed location and stored device parameters may include geographic latitude, longitude and height of the installed image capture device. The image capture device may by functionally operable to change its orientation and the field of view of the scene through features such as pan and tilt functionality that are tracked with device parameters. The image capture device may further include a laser range finder (LFR) that may be used to measure a range between the image capture device and a reference point in the scene. In various implementations, a plurality of image capture devices may be installed to capture different views of one or more scenes in an implemented system.

In operation 104, the range between the installed image capture device and a plurality of reference point locations in the scene are measured. In some embodiments, an image of a scene is captured providing a two-dimensional view of the scene. A reference point is identified in the captured image and a measurement of the range from the image capture device to a corresponding reference point in the physical, real-world scene is measured, for example, using the LFR associated with the image capture device. In some embodiments, operation 104 may be performed with a human operator positioning the LFR towards the measured reference points. In some embodiments, the setup of the image capture device may scan the scene capturing images and taking measurements of various reference points. In various embodiments, the set of reference points may be selected in various patterns (e.g., grid patterns), resolutions (e.g., the number of reference points to collect), based on aspects of the scene (e.g., location of buildings, trees, hills, areas of interest, etc.), or through other approaches that identify and measure reference points.

In operation 106, the geographic location and height of each reference point is calculated based on the stored device parameters for the installed image capture device, such as the geographic location and height of the installed system, the azimuth and elevation of the device orientation, the measured range from operation 104, and/or other available information.

In operation 108, data associated with the reference points is stored in a memory, database, and/or other storage system. The full set of reference points may be stored as geo-reference point list and may form a virtual three-dimensional map of physical world locations along with a two-dimensional map of corresponding image information.

FIG. 1B illustrates an example process 120 for processing captured images for automatic geo-location estimation for multiple identified objects, in accordance with one or more embodiments. The process 120 may be implemented, for example, by one or more logic devices of the installed image capture device and/or one or more other processing components of an implemented system (e.g., the systems of FIGS. 2 and 3 or other processing systems) and/or a system in communication with the image capture device.

In operation 122, the processing system receives image data including one or more detected images. In some embodiments, the image capture device is configured to capture images of a scene and pass the captured images and corresponding device parameters to an object detection and classification system. The object detection system may, for example, identify regions of interest that include one or more objects. The classification system may, for example, classify the object into one or more categories. In various embodiments, the objection detection and classification system may be implemented using software that identifies objects by analyzing differences between the captured image and a background image, software that implements trained artificial intelligence and/or machine learning processes (e.g., neural network inference models), or other object detection and classification approaches. The image data may include, for example, one or more captured images, data identifying a location, size, and classification of each detected object (e.g., a bounding box in the image), confidence factor, image capture device parameters, and/or other available data.

In operation 124, the processing system calculates an estimated range of each object to the image capture device based, at least in part, on the object classification and a proportion of the field of view occupied by the object. For example, after object classification the physical size of the object can be estimated based on reference objects of the same or similar type, such as a person, a vehicle, an animal, or other object. In some embodiments, the processing system accesses stored reference object data (e.g., stored in a storage device, memory, database or other storage system, such as storage 288 in FIG. 2), which includes a reference size for a classified object type. By knowing the size of the object, the proportion of the object in the captured image may be used to estimate how close/far the object was to the image capture device. In addition, a position of the object within the image may be used to determine the direction of the object from the camera, which along with the estimated range, can be used to estimate the physical location of the object.

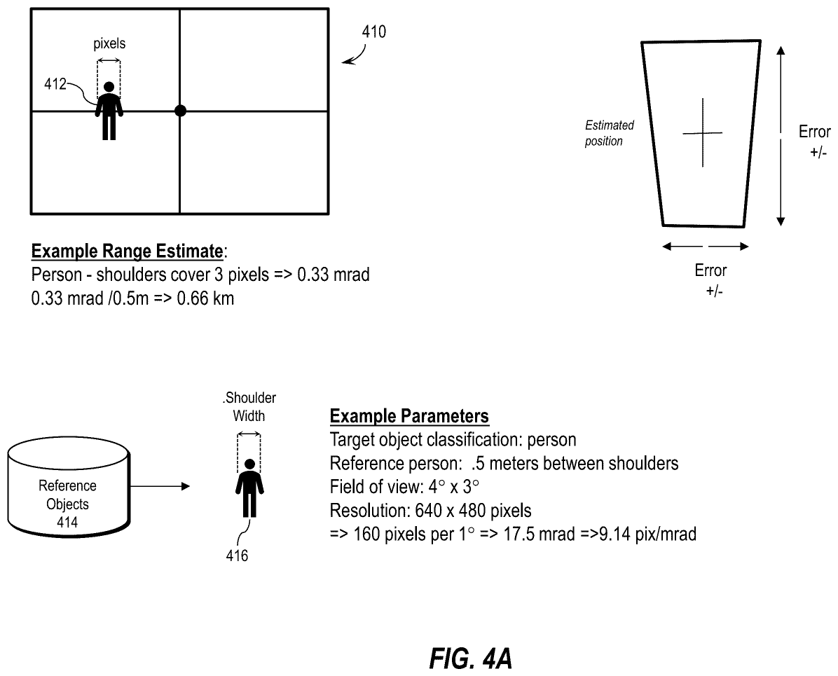

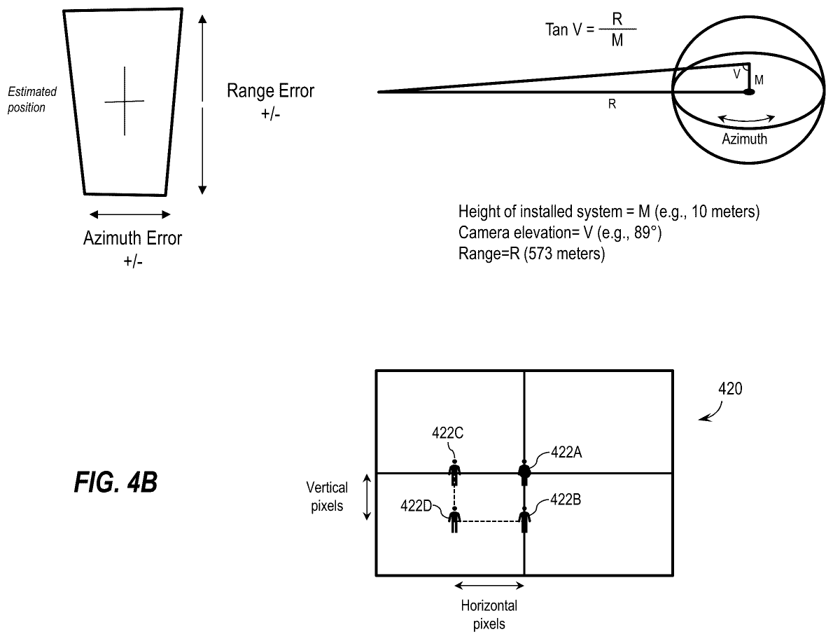

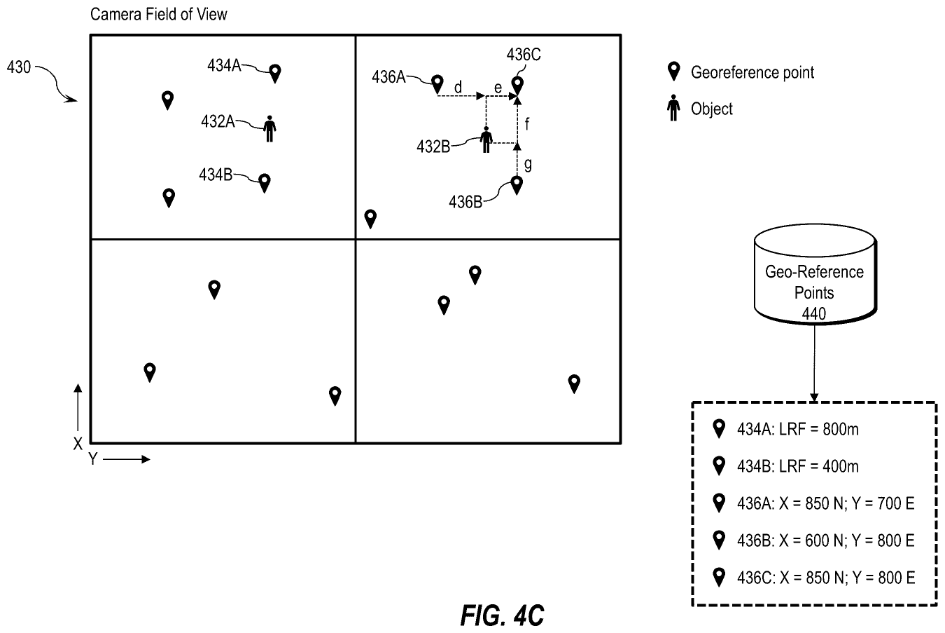

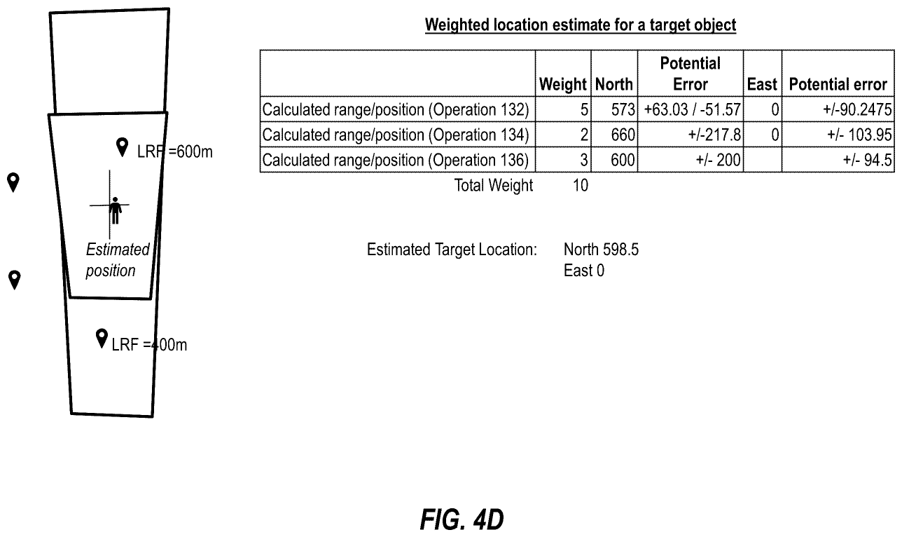

An example calculation of an estimated range based on target classification is illustrated in FIG. 4A. In this example an object 412 is detected in a captured image 410 and classified as a person. The captured image 410 has known pixel dimensions which, for example, are 640×480 pixels representing a 4°×3° field of view, which corresponds to 160 pixels per 1°=>17.5 milliradians (mrad)=>9.14 pixels/mrad in the illustrated embodiment.

The processing system looks up the classified image in a reference object storage 414 to identify object dimensions/properties of a reference object that matches or is similar to the classification. In the illustrated example, the classified object is a person and a reference object 416 is identified having reference dimensions (e.g., shoulder width) that may be used for a range estimate.

In this example, the reference object has a shoulder width of .5 meters, and the detected object 412 has a shoulder width of 3 pixels, which corresponds to 0.33 mrad (9.14 pixels per mrad/3 pixels). The 0.33 mrad/.5 meter shoulder width generates a 0.66 kilometer (km) range. In various embodiments, the estimated range is weighted in the overall result, which may be configurable in a system implementation. For example, the size of the person may have a +/−15% error due to a variation in the size of different people in the object classification, and the limited resolution may generate additional error. In the illustrated embodiment, depending on the alignment of the object 412, the shoulder width may span four pixels or two pixels, which may generate an additional error of +/−33%.

Referring back to FIG. 1B, in operation 126, the processing system determines an approximate physical location of the detected objects based on an estimated range determined from the captured two-dimensional image, and the physical location and orientation of the image capture system (e.g., geographical location, mounting height, azimuth, elevation, and other image capture system information). In some embodiments, the processing system assumes a two-dimensional, flat earth/scene for the location calculations. In some embodiments, the processing system may use elevation/height information corresponding to the terrain/scene. In some embodiments, the approximate physical location of the detected objects may be determined from the location of the objects in the captured image, independently from the estimated range determined in operation 124. Example calculations of an estimated range based on an object position in a captured image is illustrated in FIG. 4B. In this example one or more objects 422A-D are detected in a captured image 420.

When an object is in the center of the image 420, such as object 422A, the calculated range R may be determined using known values of the image capture system, including azimuth, camera height, camera elevation, and/or other values. In a fixed system, the values of the parameters may be determined on installation and stored when setting up the system. In some embodiments, the image capture system includes pan and tilt features, and the image capture system elevation V and azimuth reading may be passed as system parameters with the captured image 420.

With the image capture device at a known location, the azimuth reading and calculated range R may be used to estimate the location of object 422A. For example, given an image capture device height M (e.g., 10 meters) and a tilt angle V (e.g., a tilt angle of 89°) the range to the object 422A can be calculated as follows: Tan V=R/M. In the illustrated example, the calculation is Tan 89°=R/10, which generates an estimate range of R=573 meters to object 422A.

The outcome of this range calculation may be weighted differently than other range estimates, and this weighting may be configurable. For example, the azimuth may have an error that depends on the tolerances in the system design. If the azimuth errors can provide an offset of +/−2.5% then this gives a confidence of 95% on the azimuth. The calculated range may be weighted as well, and this weighting may also be configurable. For example, a flat landscape and a high mounting installation may provide higher accuracy than a low installation and/or a hilly landscape. An elevation error of +0.1° gives an approximated +11% longer range and −0.1° gives an approximated −9% shorter range (in the above example installation).

Range calculations for objects that are not in the center of the image, such as objects 422B-D will now be described. The captured image 420 has known pixel dimensions which, for example, are 640×480 pixels representing a 4°×3° field of view, which corresponds to 160 pixels per 1°, in the illustrated embodiment. The range to objects 422B-D may be estimated by calculating the distance in image pixels between an object 422B-D and the center of the image. For example, object 422B may be a number of pixels n below the center of the image (for example, n=80 pixels). In this example, 80 pixels corresponds to .5° in the field of view, which modifies V by .5% (e.g., V=89° elevation minus .5° below center in the image=88.5°). Using the equation Tan V=R/M with the new V value yields a range of 382 meters.

If the range to object 422C is 80 pixels, then the azimuth value is lowered by .5° (e.g., azimuth setting of 269.5° at image capture would result in an azimuth of 270° would be lowered to) 269.5°. The calculated range would be approximately the same as the object 422A in the center of the image 420 (e.g., range=573 meters), but the location of the object would be adjusted in view of the newly calculated azimuth. The range to object 422D would combine the two adjustments to elevation and azimuth. Assuming the object 422D is 80 pixels to the left of the center of the image and 80 pixels below the center of the image, the corrected range would be 382 meters and the corrected azimuth is 269.5° generating the calculated position for object 422D.

Referring back to FIG. 1B, in operation 128, the range to one or more detected objects is calculated using the stored geo-reference points, which may have been generated in accordance with the process of FIG. 1A. The stored geo-reference points data provide a virtual three-dimensional map that, conceptually, may be combined with a flat map of location estimates for better accuracy in the automatic range (and location) estimates.

An example calculation of an estimated range based on geo-reference points is illustrated in FIG. 4C. Geo-reference points are points in the terrain that are measured in advance of system operation, for example with the system's LRF during installation/setup, and that consequently has a known azimuth, elevation and range from the known location of the camera. Each geo-reference point may also have calculated geolocation which may be based on a local and/or global coordinate system. An object range/location determined using the geo-reference points in operation 128 is given a confidence level based at least in part on how close the object is to a measured geo-reference point (e.g., proximity may be measured by image pixels).

As illustrated, a captured image 430 has a known field of view of a scene, which is based on the azimuth, elevation, and location of the image capture device. The field of view also has a plurality of corresponding geo-reference points (e.g., geo-reference points 434A-B, and 436A-C) that may be retrieved from a geo-reference point storage 440. The geo-reference point storage may store a measured range (e.g., from LRF), camera parameters (e.g., azimuth, elevation, mounting height, camera location), geographic location information for each of the geo-reference points, and/or other data as appropriate.

In operation, an image 430 includes one or more detected objects 432A-B and the geo-reference points are used to estimate the range and/or location of the detected objects 432A-B. In one approach, the processing system estimates a range to the detected object using one or more geo-reference points. For example, object 432A is detected and the processing system identifies one or more geo-references points that are the closest in proximity to the detected object 432A. In the illustrated embodiment, the geo-reference points are mapped onto the two-dimensional image coordinates and the distance between the object and the geo-reference points is determined, such as geo-reference point 434A, which 800 meters away from the image capture device, and geo-reference point 434B, which is 400 meters away from the image capture device. The range to the object 432A may then be estimated based on its position in the image 430 compared to the geo-reference points 434A-B. For example, if the object is halfway between the two geo-reference points 434A-B, then the estimated range may be calculated as 600 meters from the camera, with an error of +/−200 meters. The location of the object 432A may then be determined based on the azimuth and installation location, and the estimated range.

In another approach, the location of an object, such as object 432B, may be calculated based on the geographic location of one or more geo-reference points. In this approach, the closest geo-reference points to object 432B in the image coordinate system may be determined. For example, geo-reference points 436A-C may be identified and used to estimate the location of the object 432B. The geo-reference point data may be retrieved from storage, such as geo-reference point storage 440. The location of object 432B relative to the geo-reference points is used to estimate the location of the object 432B. In the illustrated embodiment, the location of geo-reference point 436B is indicated as 600 North and 800 East, and the location of geo-reference point 436C is 850 North and 800 East. The object 432B is located in the middle of geo-reference points 436B-C, such that segment g equals segment f. The location of object 432B along the X-axis is thus 725 North (600+(850-650)/2=725). The location along the Y-axis of the image 430 is estimated between geo-reference points 436A and 436C. In this example, the object 432B is located between segment d and segment e, with segment d being twice as long as segment e. Thus, the location of object 432B along the Y-axis is 766.67 East (700+(800-700) * ⅔=766.67), which results in object 432B having a location of 725 North and 766.67 East.

Referring back to FIG. 1B, in operation 130, a refined geographic location estimate is generated based on two or more of the previous calculations. The geographic location may be determined (e.g., longitude, latitude, elevation, and/or or other physical coordinate system) along with a confidence score that indicates the accuracy of the estimate. In some embodiments, the confidence score is higher when the three location estimates are well aligned, and lower when there are more discrepancies between the three location estimates.

An example refined geographic location estimate will now be described with reference to FIG. 4D. The “total weight” may be any total value assigned and divided between the estimation models. Error values are implementation-specific and may be determined separately for each implementation and estimation scenario. The estimated target location can be displayed on a map where the estimated target location is marked. In some implementations, the uncertainty may also be marked, for example by illustrating a boundary around the target location identifying the range of potential target locations that are within the calculated error. The location system in the illustrated examples is based on a local grid system where the installation location is N=0 and E=0. Other coordinate systems may be used, such as global longitude, latitude, and elevation, which may be determined, for example, using a global positioning satellite system.

In operation 132 of FIG. 1B, the processing system outputs and/or stores object information, including the refined location estimate for the object and the confidence value. In some embodiments, a detected object may trigger an event that leads to further processing and/or notifications depending on the implemented system. For example, in a traffic monitoring scenario, the objects may be tracked through the scene and alerts may be generated based on traffic conditions, such as debris in the roadway, a traffic accident, or other traffic condition. In a video surveillance scenario, for example, objects identified as people may be tracked and an alert generated when suspicious activity is detected.

The systems and methods disclosed herein allow an image capture system, such as a video surveillance system, to generate accurate location data for a detected moving object and/or classified object in real time (or near real time). A surveillance system may generate an event report describing the object with its classification (or as unclassified moving object), location and time for the event. The system may process multiple objects and moving targets in the FOV simultaneously which increases the surveillance automation. The systems and method disclosed herein may further increase the automation in georeferencing objects that are found by a camera and highlighted by software by the creation of a range reference list combined with artificial intelligence for object classification and combined with data regarding camera location (and height), azimuth, elevation, and field of view.

Referring to FIG. 2, example embodiments of a system 200 including improved object range and georeferencing, will now be described. The system 200 may be an imaging system used, for example, to capture and process images to detect, classify, monitor, count or otherwise process objects that appear in a field of view.

In some embodiments, the system 200 may be configured to execute the processes of FIGS. 1A-B. A storage system such storage 288 including one or more memory and/or data storage components is configured to store geographic reference point data associated with a field of view of an image capture device, such as a camera component 201. The stored geographic reference point data may include a geographic location of and/or a range from the image capture device to each geographic reference point. A processing component 210, such a logic device, is configured to execute logic of a geo-referencing module 286 that is configured to execute all or part of the processes of FIGS. 1A-B. In some embodiments, the geo-referencing module 286 includes logic configured to cause the logic device to generate a first estimated location of an object detected in an image generated by the camera component 201, the first estimated location based at least in part on camera component 201 parameters and object information derived from the captured image (e.g., data generated by object/region detection module 284A and/or image classification module 284B). The geo-referencing module 286 may further include logic configured to cause the logic device to generate a second estimated location of the object based at least in part on object information derived from the image and the geographic reference points, and calculate a refined estimated location based on the first estimated location and the second estimated location.

Various components of the system 200 will now be described in further detail. As illustrated, the system 200 may be used for imaging a scene 270 in the field of view. The system 200 includes the processing component 210, a memory component 220, an image capture component 230, optical components 232 (e.g., one or more lenses configured to receive electromagnetic radiation through an aperture 234 in camera component 201 and pass the electromagnetic radiation to image capture component 230), an image capture interface component 236, an optional display component 240, a control component 250, a communication component 252, and other sensing components.

In various embodiments, the system 200 may be implemented as an imaging device, such as camera component 201, to capture image frames, for example, of the scene 270 in the field of view of camera component 201. In some embodiments, camera component 201 may include image capture component 230, optical components 232, and image capture interface component 236 housed in a protective enclosure. System 200 may represent any type of camera system that is adapted to image the scene 270 and provide associated image data. System 200 may be implemented with camera component 201 at various types of fixed locations and environments (e.g., highway overpass to track traffic, as part of a premises surveillance system, to monitor/track people, etc.). In some embodiments, camera component 201 may be mounted in a stationary arrangement to capture successive images of a scene 270. System 200 may include a portable device and may be implemented, for example, as a handheld device and/or coupled, in other examples, to various types of vehicles (e.g., a land-based vehicle, a watercraft, an aircraft, a spacecraft, or other vehicle).

Processing component 210 may include, for example, a logic device configured to perform the various operations of system 200, including any of the various operations described herein. In various embodiments, the logic device may include a microprocessor, a single-core processor, a multi-core processor, a microcontroller, a programmable logic device configured to perform processing operations, a digital signal processing (DSP) device, one or more memories for storing executable instructions (e.g., software, firmware, or other instructions), a graphics processing unit and/or any other appropriate combination of processing device and/or memory to execute instructions to perform any of the various operations described herein. Processing component 210 is adapted to interface and communicate with components 220, 230, 240, and 250 to perform method and processing steps as described herein.

Processing component 210 may also be adapted to detect, localize, and classify objects in one or more images captured by the image capture component 230, through image processing component 280. In some embodiments, the image processing component 280 may be configured to implement a trained inference network (e.g., neural network trained to detect, localize, and/or classify objects), or other software algorithms configured to detect, localize, and/or classify objects in one or more captured images. The processing component 210 (or other component of the processing component 210) may further be configured to generate and store the geo-reference points (e.g., as described in FIG. 1A), and generate location estimates for detect objects and generate a refined location estimate and confidence score (e.g., as described in FIG. 1B), such as via geo-referencing module 280. The geo-referencing module 286 may be configured to execute one or more of the geo-referencing processes disclosed herein. In some embodiments, the geo-referencing module 286 is configured to facilitate the processes of FIGS. 1A and 1B. In some embodiments, the image processing component 280 may include an object/region detection module 284A and image classification module 284B. Processing component 210 may be further adapted to generate an event report as previously described herein.

It should be appreciated that processing operations and/or instructions may be integrated in software and/or hardware as part of processing component 210, or code (e.g., software or configuration data) which may be stored in memory component 220. Embodiments of processing operations and/or instructions disclosed herein may be stored by a machine-readable medium in a non-transitory manner (e.g., a memory, a hard drive, a compact disk, a digital video disk, or a flash memory) to be executed by a computer (e.g., logic or processor-based system) to perform various methods disclosed herein. In various embodiments, the processing operations include a GenICam (Generic Interface for Cameras) interface.

Memory component 220 includes, in one embodiment, one or more memory devices (e.g., one or more memories) to store data and information. The one or more memory devices may include various types of memory including volatile and non-volatile memory devices, such as RAM (Random Access Memory), ROM (Read-Only Memory), EEPROM (Electrically-Erasable Read-Only Memory), flash memory, or other types of memory. In one embodiment, processing component 210 is adapted to execute software stored in memory component 220 and/or a machine-readable medium to perform various methods, processes, and operations in a manner as described herein.

Image capture component 230 includes, in one embodiment, one or more sensors for capturing image signals representative of a visible light image of scene 270. In one embodiment, the sensors of image capture component 230 provide for representing (e.g., converting) a captured infrared image signal of scene 270 as digital data (e.g., via an analog-to-digital converter included as part of the sensor or separate from the sensor as part of system 200). Imaging sensors may include a plurality of sensors (e.g., infrared detectors) implemented in an array or other fashion on a substrate. For example, in one embodiment, infrared sensors may be implemented as a focal plane array (FPA). Infrared sensors may be configured to detect infrared radiation (e.g., infrared energy) from a target scene including, for example, mid wave infrared wave bands (MWIR), long wave infrared wave bands (LWIR), and/or other thermal imaging bands as may be desired in particular implementations. Infrared sensors may be implemented, for example, as microbolometers or other types of thermal imaging infrared sensors arranged in any desired array pattern to provide a plurality of pixels.

Processing component 210 may be adapted to receive image signals from image capture component 230, process image signals (e.g., to provide processed image data), store image signals or image data in memory component 220, and/or retrieve stored image signals from memory component 220. In various aspects, processing component 210 may be remotely positioned, and processing component 210 may be adapted to remotely receive image signals from image capture component 230 via wired or wireless communication with image capture interface component 236, as described herein.

Display component 240 may include an image display device (e.g., a liquid crystal display (LCD)) or various other types of generally known video displays or monitors. Control component 250 may include, in various embodiments, a user input and/or interface device, such as a keyboard, a control panel unit, a graphical user interface, or other user input/output. Control component 250 may be adapted to be integrated as part of display component 240 to operate as both a user input device and a display device, such as, for example, a touch screen device adapted to receive input signals from a user touching different parts of the display screen.

Processing component 210 may be adapted to communicate with image capture interface component 236 (e.g., by receiving data and information from image capture component 230). Image capture interface component 236 may be configured to receive image signals (e.g., image frames) from image capture component 230 and communicate image signals to processing component 210 directly or through one or more wired or wireless communication components (e.g., represented by connection 237) in the manner of communication component 252 further described herein. Camera component 201 and processing component 210 may be positioned proximate to or remote from each other in various embodiments.

In one embodiment, communication component 252 may be implemented as a network interface component adapted for communication with a network including other devices in the network and may include one or more wired or wireless communication components. In various embodiments, a network 254 may be implemented as a single network or a combination of multiple networks, and may include a wired or wireless network, including a wireless local area network, a wide area network, the Internet, a cloud network service, and/or other appropriate types of communication networks.

In various embodiments, the system 200 provides a capability, in real time, to detect, classify, monitor, count, and/or otherwise analyze objects in the scene 270. For example, system 200 may be configured to capture images of scene 270 using camera component 201 (e.g., a visible or infrared camera). Captured images may be received by processing component 210 and stored in memory component 220. The image processing component 280 and object/region detection module 284A may extract from each of the captured images a subset of pixel values of scene 270 corresponding to a detected object. The image classification module 284B classifies the detected object and stores the result in the memory component 220, an object database or other memory storage in accordance with system preferences. In some embodiments, system 200 may send images or detected objects over network 254 (e.g., the Internet or the cloud) to a server system, such as image classification system 256, for remote image classification. The object/region detection module 284A and image classification module 284B provide analysis of the captured images to detect and classify one or more objects. In various embodiments, a trained image classification system (e.g., an inference model) may be implemented in a real-time environment.

The system 200 may be configured to operate with one or more computing devices, servers and/or one or more databases and may be combined with other components in an image classification system. Referring to FIG. 3, various embodiments of an optional host system 300 will now be described. The host system 300 may be implemented on one or more servers such as an application server that performs data processing and/or other software execution operations for generating, storing, classifying and retrieving images. In some embodiments, the components of the host system 300 may be distributed across a communications network, such as communications network 322. The communications network 322 may include one or more local networks such as a wireless local area network (WLAN), wide area networks such as the Internet, and other wired or wireless communications paths suitable for facilitating communications between components as described herein. The host system 300 includes communications components 314 operable to facilitate communications with one or more remote system 320 over the communications network 322.

In various embodiments, the host system 300 may operate as a general-purpose image classification system, such as a cloud-based image classification system, or may be configured to operate in a dedicated system, such as a video surveillance system that stores video and images captured in real time from a plurality of image capture devices and identifies and classifies objects using a database 302. The host system 300 may be configured to receive one or more images (e.g., an image captured from infrared camera of a video surveillance system or a visible light image) from one or more remote systems 320 and process associated object identification/classification requests. In some embodiments, the host system 300 may be configured to provide geo-referencing processing for detected objects, for example, through geo-referencing module 312.

As illustrated, the host system 300 includes one or more logic devices 304 that perform data processing and/or other software execution operations for the host system 300. The logic device 304 may include one or more logic devices as previously described, which may include microcontrollers, processors, application specific integrated circuits (ASICs), field programmable gate arrays (FPGAs) or other devices that may be used by the host system 300 to execute appropriate instructions, such as software instructions stored in memory 306 including object detection/classification component 310 (e.g., a neural network trained by the training dataset), geo-referencing module 312, and/or other processes and applications. The memory 306 may be implemented in one or more memory devices (e.g., memory components) that store executable instructions, data and information, including image data, video data, audio data, network information. In various embodiments, the host system 300 may be configured to interface with various network devices, such as a desktop computer or network server, a mobile computing device such as a mobile phone, tablet, laptop computer or other computing device having communications circuitry (e.g., wireless communications circuitry or wired communications circuitry) for connecting with other devices in the host system 300.

In various embodiments, the geo-referencing module 312 may include program logic configured to facilitate one or more of the processes of FIGS. 1A-B. In some embodiments, the geo-referencing module 312 may include same or similar logic as geo-referencing module 286. In some embodiments, geo-referencing module 286 provides local, runtime version of the logic of geo-referencing module 312. In some embodiments, one or more processes are divided among local and host systems. In the illustrated embodiment, the geo-referencing module 312 includes geo-referencing points generation module 312A facilitating all or part of the process of FIG. 1A, an object location: classification module 312B facilitating all or part of the process of operation 126, object location: pixel offset module 312C facilitating all or part of the process of operation 128, and object location: geo-reference points module 312D facilitating all or part of the process of operation 130).

The communications components 314 may include circuitry for communicating with other devices using various communications protocols. In various embodiments, communications components 314 may be configured to communicate over a wired communication link (e.g., through a network router, switch, hub, or other network devices) for wired communication purposes. For example, a wired link may be implemented with a power-line cable, a coaxial cable, a fiber-optic cable, or other appropriate cables or wires that support corresponding wired network technologies. Communications components 314 may be further configured to interface with a wired network and/or device via a wired communication component such as an Ethernet interface, a power-line modem, a Digital Subscriber Line (DSL) modem, a Public Switched Telephone Network (PSTN) modem, a cable modem, and/or other appropriate components for wired communication. Proprietary wired communication protocols and interfaces may also be supported by communications components 314.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure.

Software in accordance with the present disclosure, such as non-transitory instructions, program code, and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the invention. Accordingly, the scope of the invention is defined only by the following claims.

What is claimed is:

1. A system comprising:
a storage system configured to store geographic reference points associated with a field of view of an image capture device, the geographic reference points having a geographic location and/or a range from the image capture device;
a logic device configured to:
generate a first estimated location of an object detected in an image generated by the image capture device, the first estimated location based at least in part on image capture device parameters and object information derived from the image;
generate a second estimated location of the object based at least in part on object information derived from the image and the geographic reference points; and
calculate a refined estimated location based on the first estimated location and the second estimated location.

2. The system of claim 1, further comprising the image capture device;
wherein the image capture device is configured to capture a plurality of images of a scene within a field of view of the image capture device; and
wherein the image capture device parameters comprise a location of the image capture device, a height of the image capture device, an azimuth value, and/or a tilt value.

3. The system of claim 2, further comprising a laser range finder (LRF) configured to measure a range between the image capture device and an object within the field of view; and
wherein the logic device is further configured to:
measure a range between the image capture device and a plurality of geographic reference points within the field of view using the LRF;
calculate, for each geographic reference point, a geographic location of each reference point based the image capture device parameters and the measured range; and
store data related to each geographic reference point in the storage system, the data comprising one or more image capture device parameters and the measured range.

4. The system of claim 3, wherein the data further comprises a location of the reference point within a captured image corresponding to the LRF measurement.

5. The system of claim 1, wherein the logic device is further configured to detect one or more objects in the image and determine an object classification for each of the one or more objects; and
wherein the first estimated location is based at least in part on the object classification, proportion of the field of view occupied by the object, and reference object data.

6. The system of claim 1, wherein the refined estimated location is based on weights assigned to each of the first estimated location and the second estimated location, and/or calculated errors associated with the first estimated location and the second estimated location.

7. The system of claim 6, wherein the logic device is further configured to generate a third estimated location of the object based on an estimated range from the image capture device to the object based at least in part on the image and the image capture device parameters; and
wherein the logic device is further configured to refine the estimated location based at least in part on the third estimated location.

8. The system of claim 1, wherein the first estimated location is based at least in part on the image capture device parameter and a distance in pixels between the object and a reference point in the image.

9. The system of claim 1, wherein the system is a video surveillance system and/or a traffic monitoring system.

10. A method of operating the system of claim 1, the method comprising:
generating the first estimated location;
generating the second estimated location; and
calculating the refined estimated location.

11. A method comprising:
providing a storage system configured to store geographic reference points associated with a field of view of an image capture device, the geographic reference points having a geographic location and/or a range from the image capture device;
generating, by a logic device, a first estimated location of an object detected in an image generated by the image capture device, the first estimated location based at least in part on image capture device parameters and object information derived from the image;
generating, be a logic device, a second estimated location of the object based at least in part on object information derived from the image and the geographic reference points; and
calculating, be the logic device, a refined estimated location based on the first estimated location and the second estimated location.

12. The method of claim 11, further comprising:
capturing, using an image capture device, a plurality of images of a scene within a field of view of the image capture device; and
determining a image capture device parameters, including a location of the image capture device, a height of the image capture device, an azimuth value, and/or a tilt value.

13. The method of claim 12, further comprising:
operating a laser range finder (LRF) to measure a range between the image capture device and a location within the field of view;
calculating, for each geographic reference point, a geographic location of each reference point based the image capture device parameters and the measured range; and
storing data related to each geographic reference point in the storage system, the data comprising one or more image capture device parameters and the measured range.

14. The method of claim 13, wherein the data further comprises a location of the reference point within a captured image corresponding to the LRF measurement.

15. The method of claim 11, further comprising:
detecting and classifying one or more objects in the image; and
wherein the first estimated location is based at least in part on the object classification, proportion of the field of view occupied by the object, and reference object data.

16. The method of claim 11, wherein the refined estimated location is based on weights assigned to each of the first estimated location and the second estimated location, and/or calculated errors associated with the first estimated location and the second estimated location.

17. The method of claim 16, further comprising generating a third estimated location of the object based on an estimated range from the image capture device to the object based at least in part on the image and the image capture device parameters; and
wherein refining the estimated location is based at least in part on the third estimated location.

18. The method of claim 11, wherein the first estimated location is based at least in part on the image capture device parameter and a distance in pixels between the object and a reference point in the image.

19. The method of claim 11, further comprising using the refined estimated location in a video surveillance and/or traffic monitoring process.

20. A system configured to execute the method of claim 11.
